(19) United States
(12) Patent Application Publication
(10) Pub. No.: US 2025/0287320 A1
(43) Pub. Date: Sep. 11, 2025

(54) ANTENNA POWER ADJUSTMENT METHOD AND APPARATUS AND ELECTRONIC DEVICE

(71) Applicant: REALME CHONGQING MOBILE TELECOMMUNICATIONS CORP., LTD., Chongqing (CN)

(72) Inventor: Jiangyan YANG, Chongqing (CN)

(73) Assignee: REALME CHONGQING MOBILE TELECOMMUNICATIONS CORP., LTD., Chongqing (CN)

(21) Appl. No.: 19/193,846

(22) Filed: Apr. 29, 2025

Related U.S. Application Data
(63) Continuation of application No. PCT/CN2023/118541, filed on Sep. 13, 2023.

(30) Foreign Application Priority Data
Nov. 2, 2022 (CN) 202211362614.5

(51) Int. Cl. H04W 52/18

(52) U.S. Cl. CPC H04W 52/18

(57) ABSTRACT

Embodiments of the present application provide an antenna power adjustment method, for adjusting power of an antenna radiator in an electronic device. The method includes steps of: determining a current power adjustment scenario; determining an antenna operating frequency of the electronic device; determining a target sub-frequency band in which the antenna operating frequency is located when it is determined that the antenna operating frequency is a frequency in a preset frequency band including multiple sub-frequency bands, and determining a target power backoff value corresponding to the target sub-frequency band in which the antenna operating frequency is located based on power backoff values of the sub-frequency bands under the corresponding power adjustment scenario; and controlling power of a target antenna radiator currently operating at the antenna operating frequency to be lowered by the target power backoff value. The present application further provides an electronic device and a medium.

### CROSS REFERENCE TO RELATED APPLICATIONS

The present disclosure is a continuation of International Patent Application No. PCT/CN2023/118541, filed Sep. 13, 2023, which claims priority to Chinese Patent Application No. 202211362614.5, filed on Nov. 2, 2022, the entire contents of these applications are incorporated herein by reference.

### TECHNICAL FIELD

The present disclosure relates to the field of communication technologies, and in particular to an antenna power adjustment method, an electronic device, and a computer-readable storage medium.

### BACKGROUND

At present, mobile terminals such as mobile phones have been widely used. In order to prevent antenna radiation from causing harm to the user's body, SAR (specific absorption rate) values of the mobile phones are required to be within a safe range. Government departments, telecommunications regulatory agencies, etc. in various countries have issued corresponding regulations on electromagnetic radiation. For example, the national standard YD-T 1644.1-2007, the American standard and the European standard EN 62209-1, and the standards of other regions and organizations. The international requirements for the SAR of mobile terminals are becoming more and more stringent. Generally speaking, the SAR values are proportional to the power of an antenna. The higher the antenna power, the higher the SAR values. However, the antenna power is proportional to the antenna performance. If the antenna power is adjusted too small, it will affect the antenna performance and the user experience. Therefore, how to maximize the antenna power while ensuring compliance with the SAR values has become a problem that needs to be solved.

### SUMMARY

In a first aspect, the present disclosure provides an antenna power adjustment method, configured to adjust power of an antenna radiator in an electronic device. The method includes steps of: determining a current power adjustment scenario; determining an antenna operating frequency of the electronic device for currently transmitting and receiving an electromagnetic wave signal; determining a target sub-frequency band in which the antenna operating frequency is located when it is determined that the antenna operating frequency is a frequency in a preset frequency band including a plurality of sub-frequency bands, and determining a target power backoff value corresponding to the target sub-frequency band in which the antenna operating frequency is located based on power backoff values of the sub-frequency bands in the preset frequency band under the corresponding power adjustment scenario; and controlling power of a target antenna radiator currently operating at the antenna operating frequency to be lowered by the target power backoff value.

In a second aspect, the present disclosure provides an electronic device. The electronic device includes a plurality of antenna radiators and a processor. The processor is configured to determine a current power adjustment scenario and an antenna operating frequency of the electronic device for currently transmitting and receiving an electromagnetic wave signal, determine a target sub-frequency band in which the antenna operating frequency is located when it is determined that the antenna operating frequency is a frequency in a preset frequency band including a plurality of sub-frequency bands, determine a target power backoff value corresponding to the target sub-frequency band in which the antenna operating frequency is located based on power backoff values of the sub-frequency bands in the preset frequency band under the corresponding power adjustment scenario, and control power of a target antenna radiator currently operating at the antenna operating frequency to be lowered by the target power backoff value.

In a third aspect, the present disclosure provides a computer-readable storage medium configured to store a program. The program is configured to be called by a processor to execute an antenna power adjustment method configured to adjust power of an antenna radiator in an electronic device. The method includes steps of: determining a current power adjustment scenario; determining an antenna operating frequency of the electronic device for currently transmitting and receiving an electromagnetic wave signal; determining a target sub-frequency band in which the antenna operating frequency is located when it is determined that the antenna operating frequency is a frequency in a preset frequency band including a plurality of sub-frequency bands, and determining a target power backoff value corresponding to the target sub-frequency band in which the antenna operating frequency is located based on power backoff values of the sub-frequency bands in the preset frequency band under the corresponding power adjustment scenario; and controlling power of a target antenna radiator currently operating at the antenna operating frequency to be lowered by the target power backoff value.

### BRIEF DESCRIPTION OF THE DRAWINGS

In order to more clearly illustrate the technical solutions in the embodiments of the present disclosure or the background technology, the drawings needed to be used in the embodiments of the present disclosure or the background technology are briefly introduced below.

FIG. 1 is a schematic flow chart of an antenna power adjustment method according to some embodiments of the present disclosure.

FIG. 2 is a schematic diagram of a setting interface for every power backoff value corresponding to each sub-frequency band in a preset frequency band under multiple power adjustment scenarios according to some embodiments of the present disclosure.

FIG. 3 is a schematic diagram of sub-frequency band division, taking a preset frequency band as a WiFi 5G frequency band as an example, according to some embodiments of the present disclosure.

FIG. 4 is a schematic diagram of corresponding relationships, each representing a relationship between each sub-frequency band in a preset frequency band and a corresponding power backoff value, under multiple power adjustment scenarios, taking the preset frequency band as a WiFi 5G frequency band as an example, according to some embodiments of the present disclosure.

FIG. 5 is a further schematic diagram of corresponding relationships, each representing a relationship between each sub-frequency band in a preset frequency band and a corresponding power backoff value, under multiple power adjustment scenarios, taking the preset frequency band as a WiFi 5G frequency band as an example, according to some embodiments of the present disclosure.

FIG. 6 is a schematic diagram of corresponding relationships, each representing a relationship between each sub-frequency band in a preset frequency band and a corresponding power backoff value, under a limb approaching scenario, taking the preset frequency band as an N78 frequency band as an example, according to some embodiments of the present disclosure.

FIG. 7 is a flow chart of an antenna power adjustment method according to some embodiments of the present disclosure.

FIG. 8 is a schematic plan diagram of an electronic device according to some embodiments of the present disclosure.

FIG. 9 is a structural block diagram of an electronic device according to some embodiments of the present disclosure.

FIG. 10 is a schematic diagram of a power adjustment apparatus according to some embodiments of the present disclosure.

### DETAILED DESCRIPTION

The technical solutions in the embodiments of the present disclosure are clearly and completely described below in conjunction with the accompanying drawings in the embodiments of the present disclosure. Obviously, the described embodiments are only part of the embodiments of the present disclosure, not all of the embodiments. Based on the embodiments of the present disclosure, all other embodiments obtained by ordinary technicians in the art without creative work are within the scope of protection of the present disclosure.

Terms used in implementations of the present disclosure are only used to explain specific embodiments of the present disclosure, and are not intended to limit the present disclosure. The terms “first”, “second”, “third”, and “fourth” in the specification, claims, and the drawings of the present disclosure are used to distinguish different objects, rather than to describe a specific order. In addition, the terms “comprise”, “include”, and any variations thereof are intended to cover non-exclusive inclusions. The expression “A/B” includes two situations such as “A and B” and “A or B”, and unless otherwise specified, it generally refers to “A or B”. The term “connect” in the present disclosure includes direct connection, indirect connection, and electrical connection, etc. It should be noted that the embodiments, implementations, and related technical features of the present disclosure may be combined with each other without conflict.

An electronic device in the present disclosure may include a handheld device such as a mobile phone and a tablet computer, and may also include a vehicle mounted device, a wearable device, a computing device, or other processing devices connected to a wireless modem, as well as various forms of user equipment (UE), mobile station (MS), terminal device, etc.

It should be understood that the directional terms such as “top” and “bottom” used in the embodiments of the present disclosure to describe the electronic device are mainly illustrated based on an orientation when the user holds the electronic device in hand and uses it. A position facing a top side of the electronic device means “top”, and a position facing a bottom side of the electronic device means “bottom”. The terms do not indicate or imply that an apparatus or element referred to must have a specific orientation, be constructed and operated in a specific orientation, and therefore cannot be understood as a limitation on an orientation of the electronic device in an actual application scenario. In some embodiments, a bottom end of the electronic device is an end where a headphone jack and a USB port are provided, and a top end of the electronic device is the other end opposite to the end where the headphone jack and the USB port are provided. In some embodiments, a short side of the electronic device is a side where the top end or the bottom end of the electronic device is located, and a long side of the electronic device is a side of the electronic device connected between two short sides, or may also be a side where a button such as a volume adjustment button is provided.

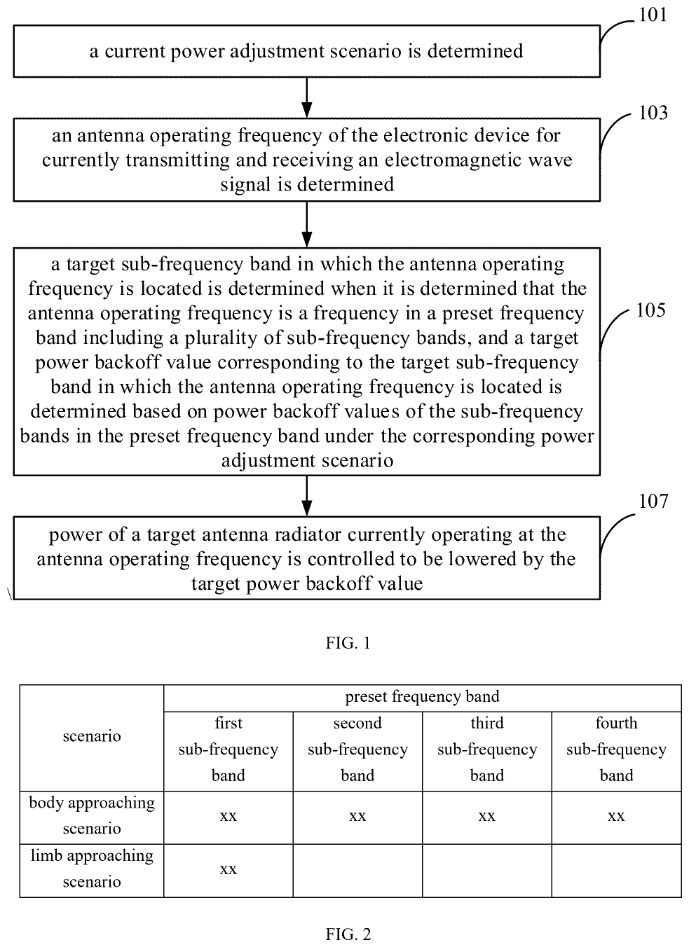

As shown in FIG. 1, which is a schematic flow chart of an antenna power adjustment method according to some embodiments of the present disclosure. The method is configured to adjust power of an antenna radiator in an electronic device. Operations included in the method are not limited to being executed by the following blocks, and an execution order of the blocks is not limited to the following order. The method may include the operations executed by the following blocks.

At block 101, a current power adjustment scenario is determined.

At block 103, an antenna operating frequency of the electronic device for currently transmitting and receiving an electromagnetic wave signal is determined.

At block 105, a target sub-frequency band in which the antenna operating frequency is located is determined when it is determined that the antenna operating frequency is a frequency in a preset frequency band including a plurality of sub-frequency bands, and a target power backoff value corresponding to the target sub-frequency band in which the antenna operating frequency is located is determined based on power backoff values of the sub-frequency bands in the preset frequency band under the corresponding power adjustment scenario.

At block 107, power of a target antenna radiator currently operating at the antenna operating frequency is controlled to be lowered by the target power backoff value.

In some designs in related art, an entire frequency band uses the same power backoff value. In order to meet SAR compliance requirements at each frequency or each frequency interval, it is necessary to use a maximum power backoff value as a power backoff value of the entire frequency band. Therefore, some frequencies or frequency intervals in the frequency band that originally did not need to back off the maximum power backoff value also underwent a large power backoff, resulting in a decrease in antenna performance when working in these frequency intervals. In the present disclosure, by dividing the preset frequency band into multiple sub-frequency bands, with each of the sub-frequency bands corresponding to a corresponding power backoff value, and then determining the target power backoff value corresponding to the target sub-frequency band in which the antenna operating frequency is located, power backoff may be achieved more precisely based on different sub-frequency bands. In this way, when the antenna radiator operates at each frequency interval/sub-frequency within the frequency band, the antenna power may be further increased on the premise of meeting the SAR compliance requirements, thereby improving the antenna performance.

The number of the sub-frequency bands included in the preset frequency band is more than or equal to 2.

In some embodiments, among power backoff values of the sub-frequency bands in the preset frequency band in each power adjustment scenario, at least some of the power backoff values are different, and the power backoff value of each sub-frequency band is smaller than or equal to a power backoff value in a case where the same power backoff value is used for the entire frequency band. In the present disclosure, the power of the target antenna radiator currently operating at the antenna operating frequency being lowered by the target power backoff value refers to the power of the target antenna radiator currently operating at the antenna operating frequency being reduced by the target power backoff value. For example, in a case where current power is 15 db and the target power backoff value is 3 db, the power of the target antenna radiator currently operating at the antenna operating frequency, which is 15 db, is lowered by the target power backoff value of 3 db, so that the power of the target antenna radiator currently operating at the antenna operating frequency becomes 12 db.

In some embodiments, the determining a target power backoff value corresponding to the target sub-frequency band in which the antenna operating frequency is located based on power backoff values of the sub-frequency bands in the preset frequency band under the corresponding power adjustment scenario, includes: obtaining a plurality of pre-generated corresponding relationships, each representing a relationship between each of the sub-frequency bands in the preset frequency band and a corresponding power backoff value, under a plurality of power adjustment scenarios; determining the target power backoff value corresponding to the target sub-frequency band in which the antenna operating frequency is located under the current power adjustment scenario based on a corresponding relationship under the current power adjustment scenario.

That is, in some embodiments, based on the pre-generated corresponding relationships, each representing a relationship between each of the sub-frequency bands in the preset frequency band and a corresponding power backoff value, under the plurality of power adjustment scenarios, the target power backoff value corresponding to the target sub-frequency band in which the antenna operating frequency is located under the current power adjustment scenario is determined.

In some embodiments, the power adjustment scenarios include at least one of a body approaching scenario and a limb approaching scenario, and the plurality of the power adjustment scenarios may include at least more than one of the above scenarios.

In some embodiments, the method further includes an operation of: pre-generating the corresponding relationships, each representing a relationship between each of the sub-frequency bands in the preset frequency band and a corresponding power backoff value, under the plurality of power adjustment scenarios. For example, the pre-generating the corresponding relationships, each representing a relationship between each of the sub-frequency bands in the preset frequency band and a corresponding power backoff value, under the plurality of power adjustment scenarios, includes: dividing the preset frequency band into the sub-frequency bands; determining every power backoff value corresponding to each of the sub-frequency bands in the preset frequency band under the plurality of the power adjustment scenarios respectively, to obtain the corresponding relationships, each representing a relationship between each of the sub-frequency bands in the preset frequency band and a corresponding power backoff value, under the plurality of the power adjustment scenarios.

In some embodiments, the dividing the preset frequency band into the sub-frequency bands, may include: dividing the preset frequency band into the sub-frequency bands in response to an input operation. That is, in some embodiments, the preset frequency band may be divided into the sub-frequency bands in response to an input operation of the user. For example, before the electronic device leaves the factory or after it is sold, the user may set up the electronic device, select at least one frequency band under at least one communication standard as the preset frequency band, and manually divide the preset frequency band into multiple sub-frequency bands. The user may determine, through experiments or simulations, a frequency range in which power backoff values need to be set are equal to each other under the premise of the SAR value compliance requirements, and take the frequency range as a sub-frequency band.

In other embodiments, the dividing the preset frequency band into the sub-frequency bands, may include: dividing the preset frequency band into the sub-frequency bands based on a frequency band division rule. In some embodiments, the frequency band division rule may include: dividing the preset frequency band into the sub-frequency bands based on a plurality of resonant frequency points included in the preset frequency band. For example, each sub-frequency band is a frequency range segment centered on a corresponding resonant frequency point, or two adjacent sub-frequency bands are two sub-frequency range segments in a frequency range segment centered on a corresponding resonant frequency point.

In some embodiments, the determining every power backoff value corresponding to each of the sub-frequency bands in the preset frequency band under the plurality of the power adjustment scenarios respectively, may include: determining every power backoff value corresponding to each of the sub-frequency bands in the preset frequency band under the plurality of the power adjustment scenarios respectively in response to an input operation. That is, in some embodiments, before the electronic device leaves the factory or after it is sold, the user may perform a setting operation on every power backoff value corresponding to each sub-frequency band in the preset frequency band under each power adjustment scenario to set every power backoff value corresponding to each sub-frequency band in the preset frequency band under each power adjustment scenario. In this way, the corresponding relationships, each representing a relationship between each of the sub-frequency bands in the preset frequency band and a corresponding power backoff value, under the plurality of the power adjustment scenarios are obtained in response to the setting operation.

As shown in FIG. 2, which is a schematic diagram of a setting interface for every power backoff value corresponding to each sub-frequency band in a preset frequency band under multiple power adjustment scenarios according to some embodiments of the present disclosure. As shown in FIG. 2, it is assumed that the multiple power adjustment scenarios include the body approaching scenario and the limb approaching scenario as described above, and the preset frequency band includes a first sub-frequency band, a second sub-frequency band, a third sub-frequency band, and a fourth sub-frequency band. The setting interface illustrates input boxes corresponding to the first sub-frequency band, the second sub-frequency band, the third sub-frequency band, and the fourth sub-frequency band respectively in the body approaching scenario, and input boxes corresponding to the first sub-frequency band, the second sub-frequency band, the third sub-frequency band, and the fourth sub-frequency band respectively in the limb approaching scenario. Thus, the user may input corresponding power backoff values through the input boxes to set every power backoff value corresponding to each sub-frequency band in the preset frequency band under each power adjustment scenario. After the user completes the setting, the corresponding relationships, each representing a relationship between each of the sub-frequency bands in the preset frequency band and a corresponding power backoff value, under the plurality of the power adjustment scenarios may be obtained.

In some embodiments, the user may obtain every power backoff value corresponding to each sub-frequency band in each power adjustment scenario through simulation or experimental debugging, so as to set every power backoff value corresponding to each sub-frequency band in the preset frequency band in each power adjustment scenario. In some embodiments, every power backoff value corresponding to each sub-frequency band in each power adjustment scenario satisfies: in the power adjustment scenario, when an operating frequency is within the sub-frequency band, the power backoff value is reduced so that the SAR value just meets a value required by safety regulations. Thus, excessive reduction of antenna power may be avoided.

In some embodiments, the electronic device to which the method is applied includes an earpiece. The determining a current power adjustment scenario includes: determining a state of the earpiece, the state of the earpiece including an on state and an off state; and determining the current power adjustment scenario based on the state of the earpiece.

That is, in some embodiments, the power adjustment scenario may be determined based on the state of the earpiece.

In some embodiments, the determining the current power adjustment scenario based on the state of the earpiece may include: determining that the current power adjustment scenario is the body approaching scenario when the state of the earpiece is the on state; and determining that the current power adjustment scenario is the limb approaching scenario when the state of the earpiece is the off state.

Since the earpiece is usually installed at the top of the electronic device, and the earpiece is usually turned on when the user's head is close to the electronic device, when the earpiece is turned on, it generally indicates the body approaching scenario where the head is close to the electronic device, and when the state of the earpiece is the off state, it generally indicates the limb approaching scenario where fingers are close to the electronic device. Therefore, the power adjustment scenario may be determined as the body approaching scenario or the limb approaching scenario based on the state of the earpiece.

In the present disclosure, the body approaching scenario refers to a scenario where the head, etc. are close to the electronic device, and the limb approaching scenario refers to a scenario where hands, fingers, etc. are close to the electronic device.

In some embodiments, the electronic device to which the method is applied includes a plurality of proximity sensors, which are arranged at different positions of the electronic device respectively. Each of the proximity sensors is configured to generate a sensing signal when sensing an approach of a human body. The determining a current power adjustment scenario includes: determining the current power adjustment scenario based on a position of at least one of the proximity sensors that generates the sensing signal.

That is, in some embodiments, the current power adjustment scenario may be determined based on a position of at least one of the proximity sensors that senses the approach of a human body.

In some embodiments, the proximity sensors include a first proximity sensor arranged at a top end of the electronic device and a second proximity sensor arranged at a bottom end of the electronic device. The determining the current power adjustment scenario based on a position of at least one of the proximity sensors that generates the sensing signal includes: determining that the current power adjustment scenario is the body approaching scenario when sensing signals of the first proximity sensor and the second proximity sensor are received at the same time; and determining that the current power adjustment scenario is the limb approaching scenario when only a sensing signal of one of the first proximity sensor and the second proximity sensor is received.

When the sensing signals of the first proximity sensor and the second proximity sensor are received at the same time, it means that the user is close to the top end and bottom end of the electronic device at the same time, which is generally a case where the user's head is close to the electronic device. Therefore, when the sensing signals of the first proximity sensor and the second proximity sensor are received at the same time, it means that a current scenario is the body approaching scenario. When only the sensing signal of one of the first proximity sensor and the second proximity sensor is received, the user is close to only one end of the electronic device at this time, which is generally a case where the user holds the electronic device in front of the body, which means that a current scenario is the limb approaching scenario.

In some embodiments, the determining a current power adjustment scenario may include: determining the current power adjustment scenario based on the state of the earpiece and the position of at least one of the proximity sensors that generates the sensing signal at the same time. For example, in some embodiments, in a case where the state of the earpiece is the on state and the sensing signals of the first proximity sensor and the second proximity sensor are received at the same time, the current power adjustment scenario is determined to be the body approaching scenario. Thus, the accuracy of scenario determination may be increased.

In some embodiments, the preset frequency band includes a frequency band with a bandwidth greater than a preset value, and the number of the preset frequency band is not less than one. The preset value may be 300 megahertz (MHZ) or the like.

That is, in some embodiments, the number of the preset frequency band may be one or more. Before the electronic device leaves the factory or after it is sold, the user may select at least one of multiple frequency bands available for selection in the electronic device as the preset frequency band. For example, a menu option of the electronic device that lists multiple frequency bands available for selection may be entered for being selected at least one of them as the preset frequency band, thereby determining the preset frequency band of the electronic device. Then, in the manner described above, for each preset frequency band, the corresponding relationships, each representing a relationship between each of the sub-frequency bands in the preset frequency band and a corresponding power backoff value, under the plurality of power adjustment scenarios is generated.

In some embodiments, the preset frequency band includes at least one of a WiFi 5G frequency band, an N77 frequency band, and an N78 frequency band. The corresponding relationships, each representing a relationship between each of the sub-frequency bands in the preset frequency band and a corresponding power backoff value, under the plurality of power adjustment scenarios includes at least one of corresponding relationships, each representing a relationship between each sub-frequency band in the WiFi 5G frequency band and a corresponding power backoff value, under the plurality of the power adjustment scenarios, corresponding relationships, each representing a relationship between each sub-frequency band in the N77 frequency band and a corresponding power backoff value, under the plurality of the power adjustment scenarios, and corresponding relationships, each representing a relationship between each sub-frequency band in the N78 frequency band and a corresponding power backoff value, under the plurality of the power adjustment scenarios.

That is, in some embodiments, the preset frequency band may include at least one of the WiFi 5G frequency band, the N77 frequency band, and the N78 frequency band. The corresponding relationships, each representing a relationship between each of the sub-frequency bands in the preset frequency band and a corresponding power backoff value, under the plurality of power adjustment scenarios also correspondingly includes at least one of the corresponding relationships, each representing a relationship between each sub-frequency band in the WiFi 5G frequency band and a corresponding power backoff value, under the plurality of the power adjustment scenarios, the corresponding relationships, each representing a relationship between each sub-frequency band in the N77 frequency band and a corresponding power backoff value, under the plurality of the power adjustment scenarios, and the corresponding relationships, each representing a relationship between each sub-frequency band in the N78 frequency band and a corresponding power backoff value, under the plurality of the power adjustment scenarios.

Thus, in some embodiments, the determining the target power backoff value corresponding to the target sub-frequency band in which the antenna operating frequency is located under the current power adjustment scenario based on a corresponding relationship under the current power adjustment scenario, may include: when it is determined that the antenna operating frequency is a frequency in the preset frequency band including multiple sub-frequency bands, the target power backoff value corresponding to the target sub-frequency band in which the antenna operating frequency is located under the current power adjustment scenario may be determined based on the corresponding relationships of the preset frequency band in which the antenna operating frequency is located.

In some embodiments, for example, when it is determined that the antenna operating frequency is a frequency in the WiFi 5G frequency band, a target power backoff value corresponding to a target sub-frequency band in the WiFi 5G frequency band in which the antenna operating frequency is located under the current power adjustment scenario may be determined based on the corresponding relationships, each representing a relationship between each sub-frequency band in the WiFi 5G frequency band and a corresponding power backoff value, under the plurality of the power adjustment scenarios.

As mentioned above, the preset frequency band may be divided into the sub-frequency bands in response to the input operation. That is, in some embodiments, the preset frequency band may be divided into the sub-frequency bands in response to the input operation of the user. For example, before the electronic device leaves the factory or after it is sold, the user may set up the electronic device, select at least one frequency band under at least one communication standard as the preset frequency band, and manually divide the preset frequency band into multiple sub-frequency bands. The user may determine, through experiments or simulations, the frequency range in which power backoff values need to be set are equal to each other under the premise of the SAR value compliance requirements, and take the frequency range as the sub-frequency band. In some embodiments, the dividing the preset frequency band into the sub-frequency bands may include: dividing the preset frequency band into the sub-frequency bands based on a frequency band division rule. In some embodiments, the frequency band division rule may be dividing the preset frequency band into the sub-frequency bands based on the resonant frequency points included in the preset frequency band. For example, each sub-frequency band is a frequency range segment centered on a corresponding resonant frequency point, or two adjacent sub-frequency bands are two sub-frequency range segments in a frequency range segment centered on a corresponding resonant frequency point. In some embodiments, as described above, the frequency band division rule may also be determining the frequency range in which power backoff values need to be set are equal to each other under the premise of the SAR value compliance requirements, and use the frequency range as a sub-frequency band.

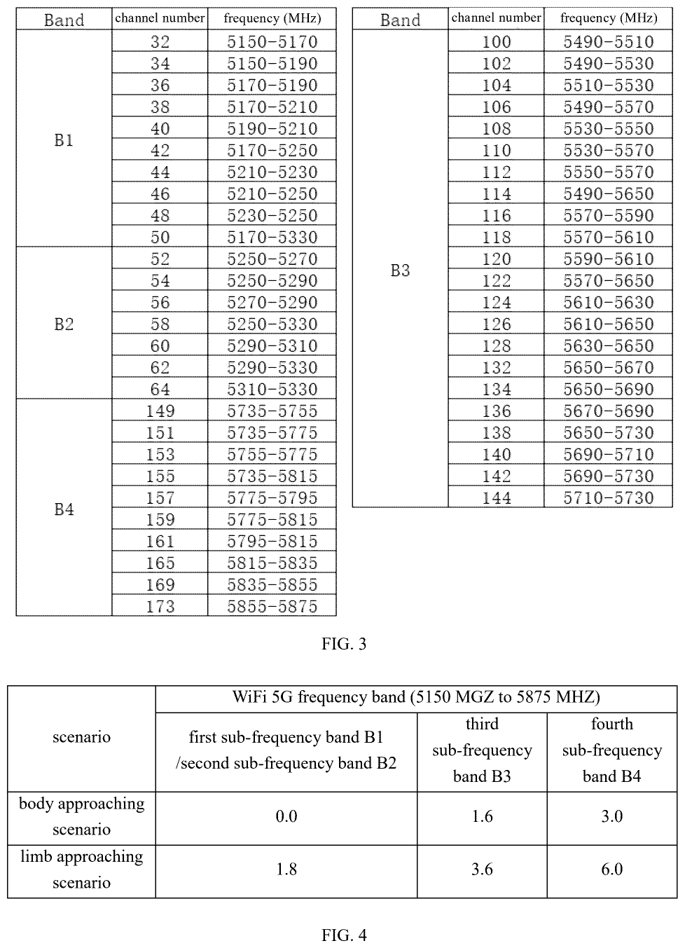

As shown in FIG. 3, which is a schematic diagram of sub-frequency band division, taking a preset frequency band as a WiFi 5G frequency band as an example, according to some embodiments of the present disclosure. A frequency range of the WiFi 5G frequency band is from 5150 MHZ to 5875 MHZ, with a total bandwidth of 725 MHZ. Within the 725 MHZ bandwidth range, a general antenna will be implemented with two modes, resulting in uneven SAR distribution within such a wide frequency range of 5150 MGZ to 5875 MHZ, and there are many cases where corresponding SAR values vary significantly. However, to meet the SAR requirements, the SAR values of all frequency points need to be reduced to within the standard. If, in some designs, the WiFi 5G frequency band adopts a mechanism of power backoff with the same power backoff value, the power configuration for reducing the SAR needs to be carried out based on a frequency point with the maximum SAR value. The frequency point with the maximum SAR value requires a maximum power backoff value for power backoff. That is, frequencies of the WiFi 5G frequency band all need to perform power backoff with the maximum power backoff value, which leads to excessive power backoff of some frequencies that do not need to be backed off with the maximum power backoff value, thus affecting the antenna performance. Therefore, as shown in FIG. 3, in the present disclosure, the WiFi 5G frequency band is divided into multiple sub-frequency bands.

The division of sub-frequency bands may be performed by selecting multiple resonant frequency points within the preset frequency band. For example, for WiFi 5G, three frequency points of 5260 MHZ, 5580 MHZ, and 5785 MHZ are selected from 5150 MGZ to 5875 MHZ. A SAR value under the body approaching scenario and a SAR value under the limb approaching scenario are tested through simulation or experimental tests. The power is set up based on SAR safety regulations and standards of relevant countries. For example, when the power is set up based on the European standards (a SAR value when the body is close is ≤2.0 W/Kg; a SAR value when the limb is close is ≤4.0 W/Kg), it can be found that different frequency ranges within the WiFi 5G frequency band, the SAR values that need to be reduced are different. Therefore, based on the differences in the SAR values that need to be reduced, the WiFi 5G frequency band may be divided into multiple sub-frequency bands.

As shown in FIG. 3, the WiFi 5G frequency band includes a first sub-frequency band B1, a second sub-frequency band B2, a third sub-frequency band B3, and a fourth sub-frequency band B4. A frequency range of the first sub-frequency band B1 is approximately from 5150 MHZ to 5330 MHZ. A frequency range of the second sub-frequency band B2 is approximately from 5250 MHZ to 5330 MHZ. A frequency range of the third sub-frequency band B3 is approximately from 5490 MHZ to 5730 MHZ. A frequency range of the fourth sub-frequency band B4 is approximately from 5735 MHZ to 5875 MHZ.

The first sub-frequency band B1 and the second sub-frequency band B2 include overlapping frequency ranges, and corresponding power backoff values may be the same, as described later for details.

As shown in FIG. 3, each sub-frequency band is further divided into a plurality of channel frequency bands based on channel numbers. For example, as shown in FIG. 3, the first sub-frequency band B1 includes a plurality of channel frequency bands with channel numbers of 32, 34, 36, 38, 40, 42, 44, 46, 48, and 50. A frequency range of the channel frequency band with channel number 32 is from 5150 MHZ to 2170 MHZ, a frequency range of the channel frequency band with channel number 34 is from 5150 MHZ to 5190 MHZ, and so on.

The determining a target sub-frequency band in which the antenna operating frequency is located, may include: determining a channel frequency band in which the antenna operating frequency is located, and determining the sub-frequency band to which the channel frequency band in which the antenna operating frequency is located belongs as the target sub-frequency band.

The division of multiple sub-frequency bands shown in FIG. 3 may be based on frequency ranges with equal power backoff values under the premise of the SAR value compliance requirements, and at the same time refer to the frequency band division rule to divide the preset frequency band into multiple sub-frequency bands.

In some embodiments, power backoff values corresponding to the first sub-frequency band B1 and the second sub-frequency band B2 are the same, and the first sub-frequency band B1 and the second sub-frequency band B2 may be combined into one sub-frequency band. That is, the division of the sub-frequency bands may be carried out through a frequency band division rule: determine the frequency range composed of multiple frequencies with an equal power backoff value that need to be set up under the premise of meeting the SAR value compliance through experiments or simulations, and take the frequency range as a sub-frequency band. In other words, under the frequency band division rule, each sub-frequency band corresponds to a power backoff value, and different sub-frequency bands correspond to different power backoff values.

As shown in FIG. 4, which a schematic diagram of corresponding relationships, each representing a relationship between each sub-frequency band in a preset frequency band and a corresponding power backoff value, under multiple power adjustment scenarios, taking the preset frequency band as a WiFi 5G frequency band as an example, according to some embodiments of the present disclosure. As shown in FIG. 4, the corresponding relationships may be in the form of a corresponding relationship table. The corresponding relationships include every power backoff value corresponding to each sub-frequency band of the WiFi 5G frequency band under the body approaching scenario, and every power backoff value corresponding to each sub-frequency band of the WiFi 5G frequency band under the limb approaching scenario.

As mentioned above, the first sub-frequency band B1 and the second sub-frequency band B2 include overlapping frequency ranges, and the corresponding power backoff values are the same. As shown in FIG. 4, under the body approaching scenario, power backoff values corresponding to the first sub-frequency band B1 and the second sub-frequency band B2 are 0 db. That is, under the body approaching scenario, when the current antenna operating frequency is within the first sub-frequency band B1 or the second sub-frequency band B2, the power of the target antenna radiator currently operating at the antenna operating frequency does not need to be backed off, i.e., does not need to be reduced. As shown in FIG. 4, under the body approaching scenario, a power backoff value corresponding to the third sub-frequency band B3 is 1.6 db, and a power backoff value corresponding to the fourth sub-frequency band B4 is 3 db.

Therefore, under the body approaching scenario, the power backoff values corresponding to the first sub-frequency band B1, the second sub-frequency band B2, and the third sub-frequency band B3 may be significantly smaller than the power backoff value corresponding to the fourth sub-frequency band B4. Thus, in the preset frequency band, that is, some sub-frequency bands in the WiFi 5G frequency band, power backoff may be performed with a smaller power backoff value, thereby ensuring compliance with the SAR value and avoiding excessive impact on the antenna performance.

As shown in FIG. 4, under the limb approaching scenario, power backoff values corresponding to the first sub-frequency band B1 and the second sub-frequency band B2 are 1.8 db, a power backoff value corresponding to the third sub-frequency band B3 is 3.6 db, and a power backoff value corresponding to the fourth sub-frequency band B4 is 6 db.

Therefore, under the limb approaching scenario, the power backoff values corresponding to the first sub-frequency band B1, the second sub-frequency band B2, and the third sub-frequency band B3 may also be significantly smaller than the power backoff value corresponding to the fourth sub-frequency band B4. Thus, in the preset frequency band, that is, some sub-frequency bands in the WiFi 5G frequency band, power backoff may be performed with a smaller power backoff value, thereby ensuring compliance with the SAR value and avoiding excessive impact on the antenna performance.

In some embodiments, when the preset frequency band includes the WiFi 5G frequency band, the power adjustment scenario includes at least one of the body approaching scenario, the limb approaching scenario, and a hotspot on-state scenario, and the plurality of power adjustment scenarios may include at least more than one of the above scenarios. In the hotspot on-state scenario, a hotspot of the electronic device is in an on state. The determining a current power adjustment scenario includes: determining that the current power adjustment scenario is the body approaching scenario when it is determined that the electronic device is both in the body approaching scenario and the hotspot on-state scenario; and determining that the current power adjustment scenario is the hotspot on-state scenario when it is determined that the electronic device is both in the limb approaching scenario and the hotspot on-state scenario.

The hotspot on-state scenario is a scenario in which the electronic device turns on the hotspot and provides access to other electronic devices to provide a network for other electronic devices. Since the electronic device will increase the radiation to the human body after the hotspot is turned on, it is necessary to perform corresponding power backoff in the hotspot on-state scenario, i.e., to be lowered by the corresponding power backoff value.

In some embodiments, a priority level of the body approaching scenario is higher than a priority level of the hotspot on-state scenario, and the priority level of the hotspot on-state scenario is higher than a priority level of the limb approaching scenario. Therefore, when the electronic device turns on the hotspot and the body such as the head is approaching, that is, the electronic device is currently both in the body approaching scenario and the hotspot on-state scenario, the power adjustment scenario is determined based on the body approaching scenario with a higher priority level, i.e., the current power adjustment scenario is determined to be the body approaching scenario. When the electronic device turns on the hotspot and the limb such as the hands is approaching, that is, the electronic device is currently both in the limb approaching scenario and the hotspot on-state scenario, the power adjustment scenario is determined based on the hotspot on-state scenario with a higher priority level, i.e., the current power adjustment scenario is determined to be the hotspot on-state scenario.

When it is determined that the current power adjustment scenario is the hotspot on-state scenario, the determining the target power backoff value corresponding to the target sub-frequency band in which the antenna operating frequency is located under the current power adjustment scenario based on a corresponding relationship under the current power adjustment scenario, may include: determining the target power backoff value corresponding to the target sub-frequency band in which the antenna operating frequency is located based on corresponding relationships, each representing a relationship between each sub-frequency band in the preset frequency band and a corresponding power backoff value, under the hotspot on-state scenario.

As shown in FIG. 5, which is a further schematic diagram of corresponding relationships, each representing a relationship between each sub-frequency band in a preset frequency band and a corresponding power backoff value, under multiple power adjustment scenarios, taking the preset frequency band as a WiFi 5G frequency band as an example, according to some embodiments of the present disclosure.

Compared with FIG. 4, FIG. 5 further illustrates the corresponding relationships, each representing a relationship between each sub-frequency band in the preset frequency band and a corresponding power backoff value, under the hotspot on-state scenario. As shown in FIG. 5, under the hotspot on-state scenario, power backoff values corresponding to the first sub-frequency band B1 and the second sub-frequency band B2 are 0 db, a power backoff value corresponding to the third sub-frequency band B3 is 1.0 db, and a power backoff value corresponding to the fourth sub-frequency band B4 is 3 db.

Therefore, under the hotspot on-state scenario, the power backoff values corresponding to the first sub-frequency band B1, the second sub-frequency band B2, and the third sub-frequency band B3 may also be significantly smaller than the power backoff value corresponding to the fourth sub-frequency band B4. Thus, in the preset frequency band, that is, some sub-frequency bands in the WiFi 5G frequency band, power backoff may be performed with a smaller power backoff value, thereby ensuring compliance with the SAR value and avoiding excessive impact on the antenna performance.

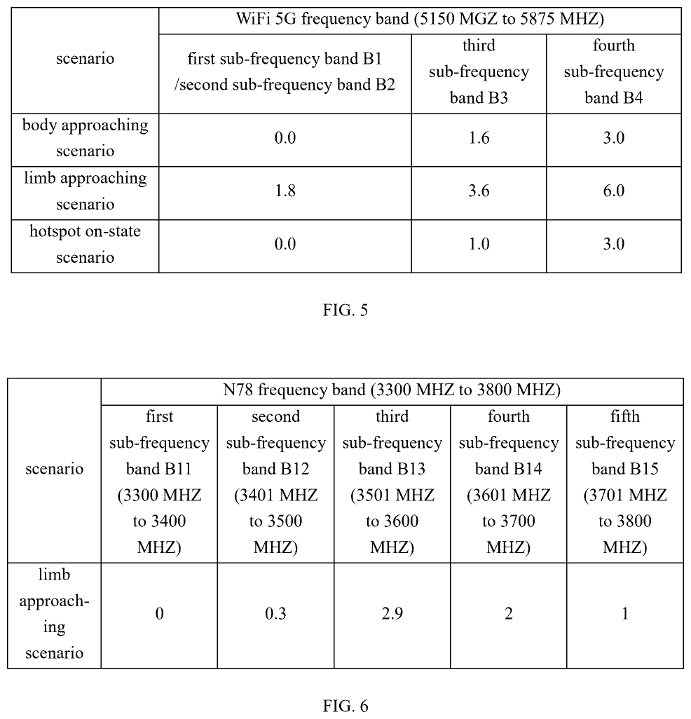

As shown in FIG. 6, which is a schematic diagram of corresponding relationships, each representing a relationship between each sub-frequency band in a preset frequency band and a corresponding power backoff value, under a limb approaching scenario, taking the preset frequency band as an N78 frequency band as an example, according to some embodiments of the present disclosure. As mentioned above, the preset frequency band may also be the N78 frequency band. FIG. 6 is a diagram of the corresponding relationships, each representing a relationship between each sub-frequency band in the N78 frequency band and a corresponding power backoff value, taking the preset frequency band is the N78 frequency band and the limb approaching scenario as an example.

A frequency range of the N78 frequency band is from 3300 MHZ to 3800 MHZ, with a bandwidth of 500 MHZ. As shown in FIG. 6, the N78 frequency band is divided into 5 sub-frequency bands, including a first sub-frequency band B11, a second sub-frequency band B12, a third sub-frequency band B13, a fourth sub-frequency band B14, and a fifth sub-frequency band B15. A frequency range of the first sub-frequency band B11 may be from 3300 MHZ to 3400 MHZ, a frequency range of the second sub-frequency band B12 may be from 3401 MHZ to 3500 MHZ, a frequency range of the third sub-frequency band B13 may be from 3501 MHZ to 3600 MHZ, a frequency range of the fourth sub-frequency band B14 may be from 3601 MHZ to 3700 MHZ, and a frequency range of the fifth sub-frequency band B15 may be from 3701 MHZ to 3800 MHZ.

As shown in FIG. 6, in the N78 frequency band under the limb approaching scenario, a power backoff value corresponding to the first sub-frequency band B11 is 0 db, a power backoff value corresponding to the second sub-frequency band B12 is 0.3 db, a power backoff value corresponding to the third sub-frequency band B13 is 2.9 db, a power backoff value corresponding to the fourth sub-frequency band B14 is 2 db, and a power backoff value corresponding to the fifth sub-frequency band B15 is 1 db.

Therefore, under the limb approaching scenario, the power backoff values corresponding to the first sub-frequency band B11, the second sub-frequency band B12, the fourth sub-frequency band B14, and the fifth sub-frequency band B15 may be significantly smaller than the power backoff value corresponding to the third sub-frequency band B13. Thus, in the preset frequency band, that is, some sub-frequency bands of the N78 frequency band, power backoff may be performed with a smaller power backoff value, thereby ensuring compliance with the SAR value and avoiding excessive impact on the antenna performance.

In some embodiments, determining that the antenna operating frequency is a frequency in a preset frequency band including a plurality of sub-frequency bands includes: determining that the antenna operating frequency is the frequency in the preset frequency band including the sub-frequency bands when it is determined that the antenna operating frequency is within a frequency range in a preset frequency band defined in a preset relationship.

That is, in some embodiments, the frequency range of the preset frequency band may be obtained through a preset frequency band defined in a pre-generated preset relationship, and then when it is determined that the antenna operating frequency is within the frequency range of the preset frequency band defined in the preset relationship, the antenna operating frequency is determined to be a frequency in the preset frequency band including multiple sub-frequency bands. In other embodiments, a preset frequency band currently set for the electronic device may be determined by querying the preset preset frequency band that has been set in advance, and a frequency range corresponding to the preset frequency band may be determined. Then, when it is determined that the antenna operating frequency is within the frequency range of the preset frequency band, the antenna operating frequency is determined to be a frequency in the preset frequency band including multiple sub-frequency bands.

Since every frequency range corresponding to each frequency band is fixed, after the preset frequency band is determined, the frequency range corresponding to the preset frequency band is also determined.

In some embodiments, the number of the antenna operating frequency in the “determining an antenna operating frequency of the electronic device for currently transmitting and receiving an electromagnetic wave signal” may be one or more.

When it is determined that the number of the antenna operating frequency of the electronic device for currently transmitting and receiving an electromagnetic wave signal is more than one, and as mentioned above, the number of the preset frequency band is not less than one, for example, is more than one, the determining a target sub-frequency band in which the antenna operating frequency is located when it is determined that the antenna operating frequency is a frequency in a preset frequency band including a plurality of sub-frequency bands, may include: determining target antenna operating frequencies among the multiple antenna operating frequencies that are located in a certain preset frequency band, and then determining every target sub-frequency band of each target antenna operating frequency located in a corresponding preset frequency band.

That is, in some embodiments, when the number of the antenna operating frequency of the electronic device for currently transmitting and receiving an electromagnetic wave signal is more than one, and the number of the preset frequency bands is also more than one, the target antenna operating frequencies located in the certain preset frequency band may be determined from the multiple antenna operating frequencies, and then every target sub-frequency band of each target antenna operating frequency located in the corresponding preset frequency band may be determined.

The obtaining a plurality of pre-generated corresponding relationships, each representing a relationship between each of the sub-frequency bands in the preset frequency band and a corresponding power backoff value, under a plurality of power adjustment scenarios, may include: obtaining the corresponding relationships, each representing a relationship between each sub-frequency band in the preset frequency band and a corresponding power backoff value, under multiple power adjustment scenarios for the corresponding preset frequency band in which each target antenna operating frequency is located.

The determining the target power backoff value corresponding to the target sub-frequency band in which the antenna operating frequency is located under the current power adjustment scenario based on a corresponding relationship under the current power adjustment scenario, includes: determining the target power backoff value corresponding to each target antenna operating frequency based on the corresponding relationships, each representing a relationship between each sub-frequency band of the preset frequency band and a corresponding power backoff value, under multiple power adjustment scenarios for the corresponding preset frequency band.

The controlling power of a target antenna radiator currently operating at the antenna operating frequency to be lowered by the target power backoff value, may include: controlling power of each target antenna radiator currently operating at the target antenna operating frequency to be lowered by a corresponding target power backoff value.

For example, the number of the antenna operating frequencies currently receiving and transmitting electromagnetic wave signals is two, and the preset frequency bands include the WiFi 5G frequency band, the N77 frequency band, and the N78 frequency band. When it is determined that a first antenna operating frequency is a frequency within the WiFi 5G frequency band and a second antenna operating frequency is a frequency within the N77 frequency band, the two antenna operating frequencies are both determined as target antenna operating frequencies located within a preset frequency band. Then a target sub-frequency band corresponding to the first antenna operating frequency located in the WiFi 5G frequency band is determined, and a first target power backoff value corresponding to the first antenna operating frequency is determined based on the corresponding relationships, each representing a relationship between each sub-frequency band in the WiFi 5G frequency band and a corresponding power backoff value, under multiple power adjustment scenarios. A target sub-frequency band corresponding to the second antenna operating frequency located in the N77 frequency band is determined, and a second target power backoff value corresponding to the second antenna operating frequency is determined based on the corresponding relationships, each representing a relationship between each sub-frequency band in the N77 frequency band and a corresponding power backoff value, under multiple power adjustment scenarios. Then, power of a first target antenna radiator currently working at the first antenna operating frequency is controlled to be lowered by the corresponding first target power backoff value, and power of a second target antenna radiator currently working at the second antenna operating frequency is controlled to be lowered by the corresponding second target power backoff value.

In some embodiments, the electronic device further includes at least one feed source, and each feed source is connected to at least one antenna radiator and is configured to provide a radio frequency excitation signal for the antenna radiator. The controlling power of a target antenna radiator currently operating at the antenna operating frequency to be lowered by the target power backoff value includes: controlling transmission power of a feed source connected to the target antenna radiator to be lowered by a corresponding power value, to control the power of the target antenna radiator to be lowered by the target power backoff value.

That is, in some embodiments, controlling the power of the target antenna radiator currently operating at the antenna operating frequency to be lowered by the target power backoff value is achieved by controlling the transmission power of the feed source connected to the target antenna radiator to be lowered by the corresponding power value.

In some embodiments, there is a corresponding relationship between a power backoff value of the target antenna radiator and a power adjustment value of the transmission power of a corresponding feed source. The controlling transmission power of a feed source connected to the target antenna radiator to be lowered by a corresponding power value, to control the power of the target antenna radiator to be lowered by the target power backoff value, may include: determining a power adjustment value corresponding to the target power backoff value based on the corresponding relationship between the power backoff value of the target antenna radiator and the power adjustment value of the transmission power of the corresponding feed source, and controlling the transmission power of the feed source connected to the target antenna radiator to be lowered by the corresponding power adjustment value, i.e., the corresponding power value.

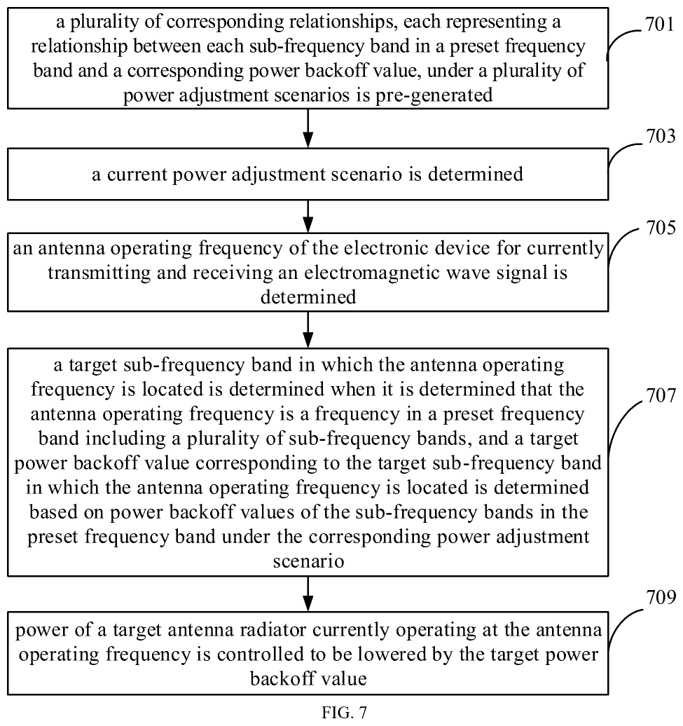

As shown in FIG. 7, which is a flow chart of an antenna power adjustment method according to some embodiments of the present disclosure. As shown in FIG. 7, the method may include the operations executed by the following blocks.

At block 701, a plurality of corresponding relationships, each representing a relationship between each sub-frequency band in a preset frequency band and a corresponding power backoff value, under a plurality of power adjustment scenarios is pre-generated.

At block 703, a current power adjustment scenario is determined.

At block 705, an antenna operating frequency of the electronic device for currently transmitting and receiving an electromagnetic wave signal is determined.

At block 707, a target sub-frequency band in which the antenna operating frequency is located is determined when it is determined that the antenna operating frequency is a frequency in a preset frequency band including a plurality of sub-frequency bands, and a target power backoff value corresponding to the target sub-frequency band in which the antenna operating frequency is located is determined based on power backoff values of the sub-frequency bands in the preset frequency band under the corresponding power adjustment scenario.

At block 709, power of a target antenna radiator currently operating at the antenna operating frequency is controlled to be lowered by the target power backoff value.

In the present disclosure, by pre-generating the corresponding relationships, each representing a relationship between each sub-frequency band in the preset frequency band and a corresponding power backoff value, under the power adjustment scenarios, the preset frequency band is divided into multiple sub-frequency bands, and each sub-frequency band corresponds to a corresponding power backoff value. Then the target power backoff value corresponding to the target sub-frequency band in which the antenna operating frequency is located is determined. In this way, power backoff may be achieved more precisely based on different sub-frequency bands. Thus, when the antenna radiator operates within each frequency interval/sub-frequency within the frequency band, the antenna power may be further increased and the antenna performance may be improved on the premise of meeting the SAR compliance requirements.

The “a plurality of corresponding relationships, each representing a relationship between each sub-frequency band in a preset frequency band and a corresponding power backoff value, under a plurality of power adjustment scenarios is pre-generated” at block 701, includes: dividing the preset frequency band into the sub-frequency bands; determining every power backoff value corresponding to each of the sub-frequency bands in the preset frequency band under the plurality of the power adjustment scenarios respectively, to obtain the corresponding relationships, each representing a relationship between each of the sub-frequency bands in the preset frequency band and a corresponding power backoff value, under the plurality of the power adjustment scenarios. The block 701 is described in detail in the above description, and please refer to the above description for details.

The block 703 to block 709 correspond to the block 101 to block 107 shown in FIG. 1 respectively. For more specific introduction, please refer to the related description of the block 101 to block 107 shown in FIG. 1.

The blocks of “an antenna operating frequency of the electronic device for currently transmitting and receiving an electromagnetic wave signal is determined” shown in FIG. 1 and FIG. 7 may be determined by a communication management chip in the electronic device based on a frequency used for transmitting and receiving the electromagnetic wave signal under a current communication standard, such as 4G, 5G, WiFi 5G, and other communication standards.

In some embodiments, the block of “power of a target antenna radiator currently operating at the antenna operating frequency is controlled to be lowered by the target power backoff value” shown in FIG. 1 and FIG. 7 may include: determining the target antenna radiator currently operating at the antenna operating frequency, and then controlling the power of the target antenna radiator currently operating at the antenna operating frequency to be lowered by the target power backoff value. The target antenna radiator currently operating at the antenna operating frequency may be determined by the communication management chip in the electronic device.

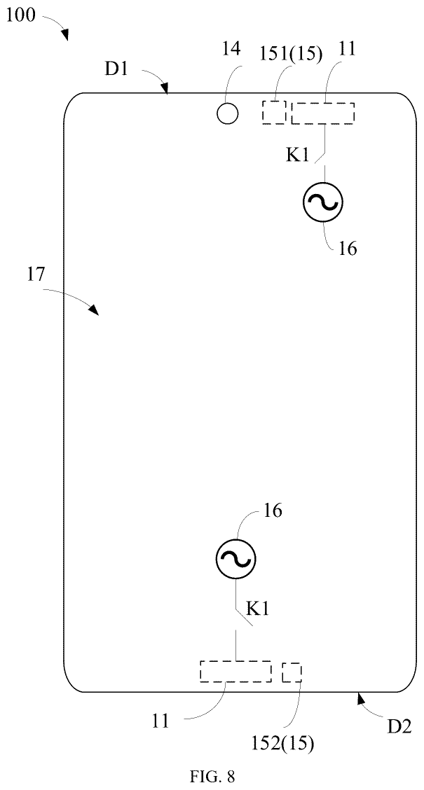

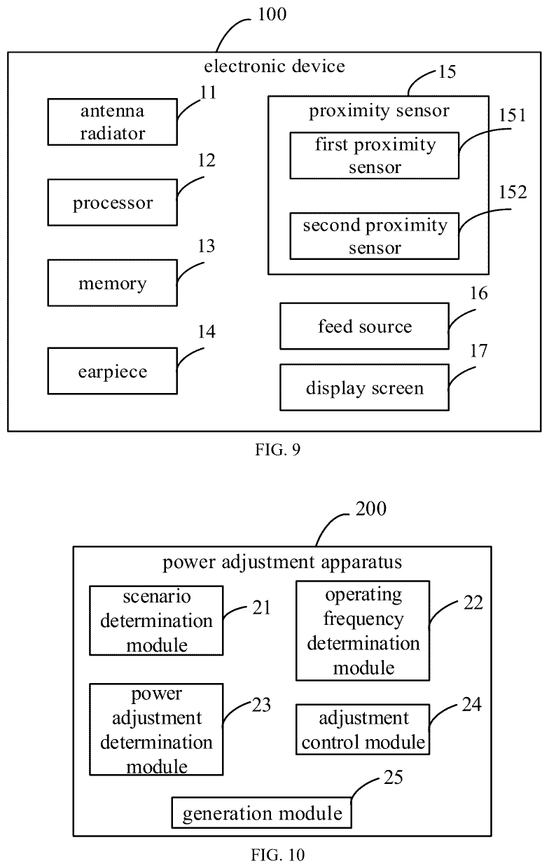

As shown in FIG. 8 and FIG. 9, FIG. 8 is a schematic plan diagram of an electronic device 100 according to some embodiments of the present disclosure, and FIG. 9 is a structural block diagram of an electronic device 100 according to some embodiments of the present disclosure.

As shown in FIG. 8 to FIG. 9, the electronic device 100 includes a plurality of antenna radiators 11 and a processor 12. The processor 12 is configured to determine a current power adjustment scenario and an antenna operating frequency of the electronic device 100 for currently transmitting and receiving an electromagnetic wave signal, determine a target sub-frequency band in which the antenna operating frequency is located when it is determined that the antenna operating frequency is a frequency in a preset frequency band including a plurality of sub-frequency bands, determine a target power backoff value corresponding to the target sub-frequency band in which the antenna operating frequency is located based on power backoff values of the sub-frequency bands in the preset frequency band under the corresponding power adjustment scenario, and control power of a target antenna radiator 11 currently operating at the antenna operating frequency to be lowered by the target power backoff value.

Therefore, the electronic device 100 of the present disclosure divides the preset frequency band into multiple sub-frequency bands, with each of the sub-frequency bands corresponding to a corresponding power backoff value, and then determines the target power backoff value corresponding to the target sub-frequency band in which the antenna operating frequency is located. In this way, power backoff may be achieved more precisely based on different sub-frequency bands, and when the antenna radiator operates at each frequency interval/sub-frequency within the frequency band, the antenna power may be further increased and the antenna performance is improved on the premise of meeting the SAR compliance requirements.

As shown in FIG. 9, the electronic device 100 also includes a memory 13. The memory 13 is configured to store a plurality of pre-generated corresponding relationships, each representing a relationship between each of the sub-frequency bands in the preset frequency band and a corresponding power backoff value, under a plurality of power adjustment scenarios. The processor 12 is configured to obtain the pre-generated corresponding relationships, each representing a relationship between each of the sub-frequency bands in the preset frequency band and a corresponding power backoff value, under the power adjustment scenarios, and determine the target power backoff value corresponding to the target sub-frequency band in which the antenna operating frequency is located under the current power adjustment scenario based on a corresponding relationship under the current power adjustment scenario.

The power adjustment scenarios include at least one of a body approaching scenario and a limb approaching scenario, and the plurality of the power adjustment scenarios may include at least more than one of the above scenarios.

In some embodiments, the processor 12 is configured to generate the corresponding relationships, each representing a relationship between each of the sub-frequency bands in the preset frequency band and a corresponding power backoff value, under the plurality of power adjustment scenarios. For example, the processor 12 is configured to divide the preset frequency band into the sub-frequency bands, determine every power backoff value corresponding to each of the sub-frequency bands in the preset frequency band under the plurality of the power adjustment scenarios respectively, to obtain the corresponding relationships, each representing a relationship between each of the sub-frequency bands in the preset frequency band and a corresponding power backoff value, under the plurality of the power adjustment scenarios, and store the corresponding relationships in the memory 13.

In some embodiments, the processor 12 dividing the preset frequency band into the sub-frequency bands, may include: the processor 12 dividing the preset frequency band into the sub-frequency bands in response to an input operation. That is, in some embodiments, the preset frequency band may be divided into the sub-frequency bands in response to an input operation of the user. For example, before the electronic device leaves the factory or after it is sold, the user may set up the electronic device, select at least one frequency band under at least one communication standard as the preset frequency band, and manually divide the preset frequency band into multiple sub-frequency bands. The user may determine, through experiments or simulations, a frequency range in which power backoff values need to be set are equal to each other under the premise of the SAR value compliance requirements, and take the frequency range as a sub-frequency band.

In other embodiments, the processor 12 dividing the preset frequency band into the sub-frequency bands, may include: the processor 12 dividing the preset frequency band into the sub-frequency bands based on a frequency band division rule. In some embodiments, the frequency band division rule may include: dividing the preset frequency band into the sub-frequency bands based on a plurality of resonant frequency points included in the preset frequency band. For example, each sub-frequency band is a frequency range segment centered on a corresponding resonant frequency point, or two adjacent sub-frequency bands are two sub-frequency range segments in a frequency range segment centered on a corresponding resonant frequency point.

In some embodiments, the processor 12 determining every power backoff value corresponding to each of the sub-frequency bands in the preset frequency band under the plurality of the power adjustment scenarios respectively, may include: the processor 12 determining every power backoff value corresponding to each of the sub-frequency bands in the preset frequency band under the plurality of the power adjustment scenarios respectively in response to an input operation. That is, in some embodiments, before the electronic device leaves the factory or after it is sold, the user may perform a setting operation on every power backoff value corresponding to each sub-frequency band in the preset frequency band under each power adjustment scenario to set every power backoff value corresponding to each sub-frequency band in the preset frequency band under each power adjustment scenario. In this way, the processor 12 may obtain the corresponding relationships, each representing a relationship between each of the sub-frequency bands in the preset frequency band and a corresponding power backoff value, under the plurality of the power adjustment scenarios in response to the setting operation. As mentioned above, every power backoff value corresponding to each sub-frequency band in the preset frequency band under each power adjustment scenario may be obtained through experiments or simulations, and the power backoff value may be a value to make the SAR value comply with the regulations exactly after the power backoff value is reduced.

As shown in FIG. 8 and FIG. 9, the electronic device 100 includes an earpiece 14. The processor 12 determining the current power adjustment scenario, includes: the processor 12 determining a state of the earpiece 14, the state of the earpiece 14 including an on state and an off state, and the processor 12 determining the current power adjustment scenario based on the state of the earpiece 14.

In some embodiments, the processor 12 determines that the current power adjustment scenario is a body approaching scenario when the earpiece 14 is in the on state, and determines that the current power adjustment scenario is a limb approaching scenario when the earpiece 14 is in the off state.

In some embodiments, as shown in FIG. 8 and FIG. 9, the electronic device 100 includes a plurality of proximity sensors 15, which are arranged at different positions of the electronic device 100 respectively. Each of the proximity sensors 15 is configured to generate a sensing signal when sensing an approach of a human body. The processor 12 determining the current power adjustment scenario, includes: the processor 12 determining the current power adjustment scenario based on a position of at least one of the proximity sensors 15 that generates the sensing signal.

In some embodiments, the processor 12 includes multiple pins (not shown). The processor 12 is connected to each proximity sensor 15 through a corresponding pin. Each pin connected to the proximity sensor 15 has a corresponding relationship with a position of the proximity sensor 15 located on the electronic device 100. When the processor 12 receives an sensing signal generated by a proximity sensor 15 through a certain pin, the processor 12 may determine a corresponding position of the proximity sensor 15 based on a corresponding relationship between the pin and the position.

In some embodiments, as shown in FIG. 8 and FIG. 9, the multiple proximity sensors 15 include at least a first proximity sensor 151 arranged at a top end D1 of the electronic device 100 and a second proximity sensor 152 arranged at a bottom end D2 of the electronic device 100. When the processor 12 simultaneously receives sensing signals of the first proximity sensor 151 and the second proximity sensor 152, the processor 12 determines that the current power adjustment scenario is the body approaching scenario. When the processor 12 receives only a sensing signal of one of the first proximity sensor 151 and the second proximity sensor 152, the processor 12 determines that the current power adjustment scenario is the limb approaching scenario.

The bottom end D2 of the electronic device 100 is an end where a headphone jack and a USB port are provided, and the top end DI of the electronic device 100 is the other end opposite to the end where the headphone jack and the USB port are provided. The top end D1 may also be an end where the camera is close. The top end D1 and the bottom end D2 are ends where short sides of the electronic device 100 are located.

The processor 12 may selectively determine the current power adjustment scenario based on the state of the earpiece 14, or selectively determine the current power adjustment scenario based on the position of at least one of the proximity sensors 15 that generates the sensing signal. In some embodiments, the proximity sensors 15 may not be arranged, and the processor 12 may determine the current power adjustment scenario based on only the state of the earpiece 14. In some embodiments, the processor 12 may determine the current power adjustment scenario based on only the position of at least one of the proximity sensors 15 that generates the sensing signal.

In some embodiments, the processor 12 may also determine the current power adjustment scenario based on the state of the earpiece 14 and the position of at least one of the proximity sensors 15 that generates the sensing signal. For example, in some embodiments, the processor 12 determines that the current power adjustment scenario is the body approaching scenario only when the state of the earpiece 14 is the on state and the sensing signals of the first proximity sensor 151 and the second proximity sensor 152 are received at the same time.

In some embodiments, the preset frequency band includes a frequency band with a bandwidth greater than a preset value, and the number of the preset frequency band is not less than one.

In some embodiments, the preset frequency band includes at least one of a WiFi 5G frequency band, an N77 frequency band, and an N78 frequency band. the corresponding relationships, each representing a relationship between each of the sub-frequency bands in the preset frequency band and a corresponding power backoff value, under the plurality of power adjustment scenarios includes at least one of corresponding relationships, each representing a relationship between each sub-frequency band in the WiFi 5G frequency band and a corresponding power backoff value, under the plurality of the power adjustment scenarios, corresponding relationships, each representing a relationship between each sub-frequency band in the N77 frequency band and a corresponding power backoff value, under the plurality of the power adjustment scenarios, and corresponding relationships, each representing a relationship between each sub-frequency band in the N78 frequency band and a corresponding power backoff value, under the plurality of the power adjustment scenarios.

The technical solutions provided in some embodiments of the present disclosure, in the context of the application of technologies such as 5G multi-frequency bands and multiple antennas, with the increasing the number of multi-antenna simultaneous transmission and the tightening of international SAR standards, may reduce SAR values in different frequency bands of 5G WIFI respectively. This enables better compliance with strict SAR standards, and ensures that the performance degradation of over the air (OTA, a kind of test for verifying the transmit power and receiving performance of the air interface in mobile communication) of the entire device is minimized. It not only meets the more stringent SAR value requirements, but also improves the OTA performance of the entire device, that is, the antenna performance, thereby enhancing the user experience.

In some embodiments, when the preset frequency band includes the WiFi 5G frequency band, the power adjustment scenario includes at least one of the body approaching scenario, the limb approaching scenario, and a hotspot on-state scenario, and the plurality of power adjustment scenarios may include at least more than one of the above scenarios. In the hotspot on-state scenario, a hotspot of the electronic device is in an on state. The processor 12 determining the current power adjustment scenario, includes: determining that the current power adjustment scenario is the body approaching scenario when it is determined that the electronic device 100 is both in the body approaching scenario and the hotspot on-state scenario; and determining that the current power adjustment scenario is the hotspot on-state scenario when it is determined that the electronic device 100 is both in the limb approaching scenario and the hotspot on-state scenario.

In some embodiments, the processor 12 determining that the antenna operating frequency is a frequency in a preset frequency band including a plurality of sub-frequency bands, includes: when the processor 12 determines that the antenna operating frequency is within a frequency range in a preset frequency band defined in a preset relationship, the processor 12 determining that the antenna operating frequency is the frequency in the preset frequency band including the sub-frequency bands.

As shown in FIG. 8 and FIG. 9, the electronic device 100 includes at least one feed source 16. Each feed source 16 is connected to at least one antenna radiator 11 and is configured to provide a radio frequency excitation signal for the antenna radiator 11. The processor 12 is configured to control transmission power of a feed source 16 connected to the target antenna radiator 11 to be lowered by a corresponding power value to control the power of the target antenna radiator 11 to be lowered by the target power backoff value.

In some embodiments, as shown in FIG. 8, a switch K1 may be arranged between the feed source 16 and the antenna radiator 11. The processor 12 may control the switch Kl to be alternately turned on and turned off by generating a (pulse width modulation) PWM control signal to the switch K1. The processor 12 may adjust a transmission power output from the feed source 16 to the antenna radiator 11 by adjusting a duty cycle of the PWM control signal.

As shown in FIG. 8, the electronic device 100 includes a display screen 17. FIG. 8 is a schematic diagram viewed from a side of the display screen 17.

The antenna power adjustment method introduced in the aforementioned FIG. 1 to FIG. 7 may be applied to the electronic device 100 shown in FIG. 8 to FIG. 9. The blocks of the antenna power adjustment method introduced in FIG. 1 to FIG. 7 may all be carried out through functions executed by the processor 12 of the electronic device 100. For more specific content about the electronic device 100, please refer to the relevant description of the aforementioned FIG. 1 to FIG. 7, which will not be repeated here.

In some embodiments, the memory 13 of the electronic device 100 stores a program. The program is configured to be called by the processor 12 to execute the blocks of the method in any of the aforementioned embodiments.

For example, the program is configured to be called by the processor 12 to execute the steps as follow.

An antenna operating frequency of the electronic device for currently transmitting and receiving an electromagnetic wave signal is determined.

A target sub-frequency band in which the antenna operating frequency is located is determined when it is determined that the antenna operating frequency is a frequency in a preset frequency band including a plurality of sub-frequency bands, and a target power backoff value corresponding to the target sub-frequency band in which the antenna operating frequency is located is determined based on power backoff values of the sub-frequency bands in the preset frequency band under the corresponding power adjustment scenario.

Power of a target antenna radiator currently operating at the antenna operating frequency is controlled to be lowered by the target power backoff value.

For specific descriptions of other blocks of the method that the program is configured to be called by the processor 12 for execution, please refer to the relevant descriptions of the aforementioned FIG. 1 to FIG. 7, which will not be repeated here.

The electronic device 100 may include other components, which are not introduced here because they are irrelevant to the improvement of the present disclosure.

As shown in FIG. 10, which is a schematic diagram of a power adjustment apparatus 200 according to some embodiments of the present disclosure. As shown in FIG. 10, the power adjustment apparatus 200 includes a scenario determination module 21, an operating frequency determination module 22, a power adjustment determination module 23, and an adjustment control module 24. The power adjustment apparatus 200 is configured to control the power of an antenna radiator in an electronic device.

The scenario determination module 21 is configured to determine the current power adjustment scenario. The operating frequency determination module 22 is configured to determine an antenna operating frequency of the electronic device for currently transmitting and receiving an electromagnetic wave signal. The power adjustment determination module 23 is configured to determine a target sub-frequency band in which the antenna operating frequency is located when it is determined that the antenna operating frequency is a frequency in a preset frequency band including a plurality of sub-frequency bands, and determine a target power backoff value corresponding to the target sub-frequency band in which the antenna operating frequency is located based on power backoff values of the sub-frequency bands in the preset frequency band under the corresponding power adjustment scenario. The adjustment control module 24 is configured to control power of a target antenna radiator currently operating at the antenna operating frequency to be lowered by the target power backoff value.

Therefore, through the power adjustment apparatus 200 of the present disclosure, the preset frequency band is divided into multiple sub-frequency bands, with each of the sub-frequency bands corresponding to a corresponding power backoff value, and then the target power backoff value corresponding to the target sub-frequency band in which the antenna operating frequency is located is determined. In this way, power backoff may be achieved more precisely based on different sub-frequency bands, and when operating at each frequency interval/sub-frequency within the frequency band, the antenna power may be further increased on the premise of meeting the SAR compliance requirements.

In some embodiments, the power adjustment determination module 23 is configured to: obtain a plurality of pre-generated corresponding relationships, each representing a relationship between each of the sub-frequency bands in the preset frequency band and a corresponding power backoff value, under a plurality of power adjustment scenarios; determine the target power backoff value corresponding to the target sub-frequency band in which the antenna operating frequency is located under the current power adjustment scenario based on a corresponding relationship under the current power adjustment scenario.

The power adjustment scenarios include at least one of a body approaching scenario and a limb approaching scenario, and the plurality of the power adjustment scenarios may include at least more than one of the above scenarios.

As shown in FIG. 10, the power adjustment apparatus 200 may include a generation module 25. The generation module 25 is configured to generate the corresponding relationships, each representing a relationship between each of the sub-frequency bands in the preset frequency band and a corresponding power backoff value, under the plurality of power adjustment scenarios. For example, the generation module 25 is configured to divide the preset frequency band into the sub-frequency bands; determine every power backoff value corresponding to each of the sub-frequency bands in the preset frequency band under the plurality of the power adjustment scenarios respectively, to obtain the corresponding relationships, each representing a relationship between each of the sub-frequency bands in the preset frequency band and a corresponding power backoff value, under the plurality of the power adjustment scenarios.

In some embodiments, the electronic device includes an earpiece. The scenario determination module 21 is configured to determine a state of the earpiece and determine the current power adjustment scenario based on the state of the earpiece. The state of the earpiece includes an on state and an off state.

In some embodiments, the scenario determination module 21 is configured to determine that the current power adjustment scenario is the body approaching scenario when the state of the earpiece is the on state; and determine that the current power adjustment scenario is the limb approaching scenario when the state of the earpiece is the off state.

In some embodiments, the electronic device includes multiple proximity sensors, which are arranged at different positions of the electronic device respectively. Each proximity sensor is configured to generate a sensing signal when sensing an approach of a human body. The scenario determination module 21 is configured to determine the current power adjustment scenario based on a position of at least one of the proximity sensors that generates the sensing signal.

The proximity sensors include a first proximity sensor arranged at a top end of the electronic device and a second proximity sensor arranged at a bottom end of the electronic device. The scenario determination module 21 is configured to determine that the current power adjustment scenario is the body approaching scenario when sensing signals of the first proximity sensor and the second proximity sensor are received at the same time; and determine that the current power adjustment scenario is the limb approaching scenario when only a sensing signal of one of the first proximity sensor and the second proximity sensor is received.

In some embodiments, the preset frequency band includes a frequency band with a bandwidth greater than a preset value, and the number of the preset frequency band is not less than one.

In some embodiments, the preset frequency band includes at least one of a WiFi 5G frequency band, an N77 frequency band, and an N78 frequency band. the corresponding relationships, each representing a relationship between each of the sub-frequency bands in the preset frequency band and a corresponding power backoff value, under the plurality of power adjustment scenarios includes at least one of corresponding relationships, each representing a relationship between each sub-frequency band in the WiFi 5G frequency band and a corresponding power backoff value, under the plurality of the power adjustment scenarios, corresponding relationships, each representing a relationship between each sub-frequency band in the N77 frequency band and a corresponding power backoff value, under the plurality of the power adjustment scenarios, and corresponding relationships, each representing a relationship between each sub-frequency band in the N78 frequency band and a corresponding power backoff value, under the plurality of the power adjustment scenarios.

In some embodiments, when the preset frequency band includes the WiFi 5G frequency band, the power adjustment scenario includes at least one of the body approaching scenario, the limb approaching scenario, and a hotspot on-state scenario, and the plurality of power adjustment scenarios may include at least more than one of the above scenarios. In the hotspot on-state scenario, a hotspot of the electronic device is in an on state. The scenario determination module 21 is configured to: determine that the current power adjustment scenario is the body approaching scenario when it is determined that the electronic device is both in the body approaching scenario and the hotspot on-state scenario; and determine that the current power adjustment scenario is the hotspot on-state scenario when it is determined that the electronic device is both in the limb approaching scenario and the hotspot on-state scenario.

The power adjustment determination module 23 determining that the antenna operating frequency is a frequency in a preset frequency band including a plurality of sub-frequency bands may include: the power adjustment determination module 23 determining that the antenna operating frequency is the frequency in the preset frequency band including the sub-frequency bands when the power adjustment determination module 23 determines that the antenna operating frequency is within a frequency range in a preset frequency band defined in a preset relationship.

In some embodiments, the electronic device further includes at least one feed source, and each feed source is connected to at least one antenna radiator and is configured to provide a radio frequency excitation signal for the antenna radiator. The adjustment control module 24 is configured to control transmission power of a feed source connected to the target antenna radiator to be lowered by a corresponding power value to control the power of the target antenna radiator to be lowered by the target power backoff value.

The electronic device controlled by the power adjustment apparatus 200 may be the electronic device 100 shown in FIG. 8 to FIG. 9.

The power adjustment apparatus 200 may be included in the electronic device 100. For example, each module in the power adjustment apparatus 200 may be a program module or a hardware unit embedded in different chips of the electronic device 100. For example, the scenario determination module 21, the operating frequency determination module 22, the power adjustment determination module 23, the adjustment control module 24, and the generation module 25 may be program modules or hardware units embedded in the processor 12.

In some embodiments, each module in the power adjustment apparatus 200 may also be a program stored in the memory 13, and is called by the processor 12 to execute corresponding functions.

The functional operations performed by the power adjustment apparatus 200 correspond to the steps of the method in the aforementioned FIG. 1 to FIG. 7 and the relevant structures of the electronic device 100. More specific contents may be referenced to each other and will not be repeated here.

The embodiment of the present disclosure provides a computer-readable storage medium. The computer-readable storage medium is configured to store a program for electronic data exchange. The program enables a computer to execute part or all of the blocks of any method described in the above method embodiments. The computer includes the above electronic device. The computer-readable storage medium may be the memory 13, etc., or may be other storage medium, such as a CD, a USB flash drive, a flash memory card, etc.

For example, the program enables the computer to execute the following steps: determining a current power adjustment scenario; determining an antenna operating frequency of the electronic device for currently transmitting and receiving an electromagnetic wave signal; determining a target sub-frequency band in which the antenna operating frequency is located when it is determined that the antenna operating frequency is a frequency in a preset frequency band including a plurality of sub-frequency bands, and determining a target power backoff value corresponding to the target sub-frequency band in which the antenna operating frequency is located based on power backoff values of the sub-frequency bands in the preset frequency band under the corresponding power adjustment scenario; and controlling power of a target antenna radiator currently operating at the antenna operating frequency to be lowered by the target power backoff value.

For the other steps that the program enables the computer to execute, please refer to the relevant descriptions of the aforementioned FIG. 1 to FIG. 7, which will not be repeated here.

The embodiment of the present disclosure provides a chip, which is configured to call a program and execute some or all of the steps of any method recorded in the above method embodiments. For example, the chip is configured to call the program and execute the following steps: determining a current power adjustment scenario; determining an antenna operating frequency of the electronic device for currently transmitting and receiving an electromagnetic wave signal; determining a target sub-frequency band in which the antenna operating frequency is located when it is determined that the antenna operating frequency is a frequency in a preset frequency band including a plurality of sub-frequency bands, and determining a target power backoff value corresponding to the target sub-frequency band in which the antenna operating frequency is located based on power backoff values of the sub-frequency bands in the preset frequency band under the corresponding power adjustment scenario; and controlling power of a target antenna radiator currently operating at the antenna operating frequency to be lowered by the target power backoff value.

For the other steps that the chip is configured to execute after calling the program, please refer to the relevant descriptions of the aforementioned FIG. 1 to FIG. 7, which will not be repeated here.

Therefore, in the antenna power adjustment method, power adjustment apparatus, electronic device, and computer-readable storage medium provided in the present disclosure, by dividing the preset frequency band into multiple sub-frequency bands, with each of the sub-frequency bands corresponding to a corresponding power backoff value, and then determining the target power backoff value corresponding to the target sub-frequency band in which the antenna operating frequency is located, power backoff may be achieved more precisely based on different sub-frequency bands. In this way, when operating at each frequency interval/sub-frequency within the frequency band, the antenna power may be further increased on the premise of meeting the SAR compliance requirements.

The above-mentioned embodiments mainly introduce the scheme of the embodiments of the present disclosure from a perspective of a method execution process side in combination with a hardware framework. It is understandable that, in order to realize the above-mentioned functions, the electronic device includes a hardware structure and/or software module corresponding to each function. It should be easily appreciated by those skilled in the art that, in combination with units and algorithm steps of each example described in the embodiments disclosed herein, the present disclosure may be implemented in a form of hardware or a combination of hardware and computer software. Whether a function is executed in the form of hardware or computer software driving hardware depends on the specific application and design constraints of the technical solution. Professional and technical personnel can use different methods to implement the described functions for each specific application, but such implementation should not be considered to be beyond the scope of the present disclosure.

The various apparatuses and products described in the above embodiments include modules/units, which may be software modules/units or hardware modules/units, or may be partially software modules/units and partially hardware modules/units. For example, for each apparatus or product that applies to or integrates a chip, each module/unit included therein may be implemented in the form of hardware such as circuits, or at least some modules/units may be implemented in the form of software programs, which run on an integrated processor inside the chip, and the remaining modules/units may be implemented in the form of hardware such as circuits. For each apparatus or product that applies to or integrates a chip module, each module/unit included therein may be implemented in the form of hardware such as circuits, and different modules/units may be located in the same component (e.g., a chip, a circuit module, etc.) or in different components of the chip module, at least some modules/units may be implemented in the form of software programs, which run on the integrated processor inside the chip module, and the remaining modules/units may be implemented in the form of hardware such as circuits. For each apparatus or product that applies to or integrates a terminal, the modules/units included therein may be implemented in the form of hardware such as circuits, and different modules/units may be located in the same component (e.g., a chip, a circuit module, etc.) or in different components in the terminal, or at least some modules/units may be implemented in the form of software programs, which run on the integrated processor inside the terminal, and the remaining modules/units may be implemented in the form of hardware such as circuits.

The embodiments of the present disclosure may divide the electronic device into functional units based on the method example. For example, each functional unit may be divided based on each function, or two or more functions may be integrated into one processing unit. The integrated unit may be implemented in the form of hardware or in the form of software functional units. It should be noted that the division of units in the embodiments of the present disclosure is schematic and is only a logical function division. There may be other division manners in actual implementation.

The present disclosure provides a computer program product. The computer program product includes a non-transitory computer-readable storage medium storing a computer program. The computer program is operable to enable a computer to execute some or all of the steps of any method described in the method embodiments. The computer program product may be a software installation package, and the computer includes the electronic device.

It should be noted that, for the aforementioned method embodiments, for the sake of simplicity, they are all expressed as a series of action combinations, but those skilled in the art should be aware that the present disclosure is not limited by the described order of actions, because according to the present disclosure, certain steps may be performed in other orders or simultaneously. Secondly, those skilled in the art should also be aware that the embodiments described in the specification are all preferred embodiments, and the actions and modules involved are not necessarily required by the present disclosure.

In the above embodiments, the description of each embodiment has its own emphasis. For parts that are not described in detail in a certain embodiment, reference may be made to the relevant descriptions of other embodiments.

In the embodiments provided in the present disclosure, it should be understood that the disclosed apparatuses may be implemented in other ways. For example, the apparatus embodiments described above are only schematic, such as the division of the above-mentioned units, which is only a logical function division. There may be other division methods in actual implementation, such as multiple units or components may be combined or integrated into another system, or some features may be ignored or not executed. Another point is that the mutual coupling or direct coupling or communication connection shown or discussed may be through some interfaces, and the indirect coupling or communication connection of apparatuses or units may be electrical or other forms.

The units described above as separate components may or may not be physically separated, and the components shown as units may or may not be physical units, that is, they may be located in one place or distributed on multiple network units. Some or all of the units may be selected based on actual requirements to achieve the purpose of the solutions of the embodiments.

In addition, all functional units in all embodiments of the present disclosure may be integrated into one processing unit, or each unit may exist physically separately, or two or more units may be integrated into one unit. The above-mentioned integrated unit may be implemented in the form of hardware or in the form of software functional units.

If the above-mentioned integrated unit is implemented in the form of a software functional unit and sold or used as an independent product, it may be stored in a computer-readable memory. Based on this understanding, the technical solutions of the present disclosure are essentially or the part that contributes to the related art or all or part of the technical solutions may be embodied in the form of a software product. The computer software product is stored in a memory, including the number of instructions to enable a computer device (which may be a personal computer, server, or network device, etc.) to perform all or part of the steps of the above-mentioned methods of each embodiment of the present disclosure. The aforementioned memory includes various media that may store program code, such as a USB flash drive, a read-only memory (ROM), a random access memory (RAM), a mobile hard disk, a magnetic disk, or an optical disk, etc.

A person skilled in the art can understand that all or part of the steps in the various methods of the above embodiments may be completed by instructing related hardware through a program, and the program may be stored in a computer-readable memory. The memory may include a flash drive, a read-only memory (ROM), a random access memory (RAM), a magnetic disk, or an optical disk, etc.

The embodiments of the present disclosure are introduced in detail above. Specific examples are used in the specification to illustrate the principles and implementation methods of the present disclosure. The description of the above embodiments is only used to help understand the methods of the present disclosure and its core idea. At the same time, for general technical personnel in the art, based on the idea of the present disclosure, there will be changes in the specific implementation method and application scope. In summary, the content of the specification should not be understood as a limitation on the present disclosure.

1. An antenna power adjustment method, configured to adjust power of an antenna radiator in an electronic device, and comprising:
determining a current power adjustment scenario;
determining an antenna operating frequency of the electronic device for currently transmitting and receiving an electromagnetic wave signal;
determining a target sub-frequency band in which the antenna operating frequency is located when it is determined that the antenna operating frequency is a frequency in a preset frequency band comprising a plurality of sub-frequency bands, and determining a target power backoff value corresponding to the target sub-frequency band in which the antenna operating frequency is located based on power backoff values of the sub-frequency bands in the preset frequency band under the corresponding power adjustment scenario; and
controlling power of a target antenna radiator currently operating at the antenna operating frequency to be lowered by the target power backoff value.

2. The antenna power adjustment method according to claim 1, wherein the determining a target power backoff value corresponding to the target sub-frequency band in which the antenna operating frequency is located based on power backoff values of the sub-frequency bands in the preset frequency band under the corresponding power adjustment scenario, comprises:
obtaining a plurality of pre-generated corresponding relationships, each representing a relationship between each of the sub-frequency bands in the preset frequency band and a corresponding power backoff value, under a plurality of power adjustment scenarios;
determining the target power backoff value corresponding to the target sub-frequency band in which the antenna operating frequency is located under the current power adjustment scenario based on a corresponding relationship under the current power adjustment scenario.

3. The antenna power adjustment method according to claim 2, further comprising:
dividing the preset frequency band into the sub-frequency bands;
determining every power backoff value corresponding to each of the sub-frequency bands in the preset frequency band under the plurality of the power adjustment scenarios respectively, to obtain the corresponding relationships, each representing a relationship between each of the sub-frequency bands in the preset frequency band and a corresponding power backoff value, under the plurality of the power adjustment scenarios.

4. The antenna power adjustment method according to claim 2, wherein the electronic device comprises an earpiece, and the determining a current power adjustment scenario, comprises:
determining a state of the earpiece, wherein the state of the earpiece comprises an on state and an off state;
determining the current power adjustment scenario based on the state of the earpiece, wherein the power adjustment scenarios comprise at least one of a body approaching scenario and a limb approaching scenario.

5. The antenna power adjustment method according to claim 2, wherein the electronic device comprises a plurality of proximity sensors arranged at different positions of the electronic device respectively, each of the proximity sensors is configured to generate a sensing signal when sensing an approach of a human body; and the determining a current power adjustment scenario, comprises:
determining the current power adjustment scenario based on a position of at least one of the proximity sensors that generates the sensing signal, wherein the power adjustment scenarios comprise at least one of a body approaching scenario and a limb approaching scenario.

6. The antenna power adjustment method according to claim 2, wherein the preset frequency band comprises a frequency band with a bandwidth greater than a preset value, and the number of the preset frequency band is not less than one.

7. The antenna power adjustment method according to claim 6, wherein the preset frequency band comprises at least one of a WiFi 5G frequency band, an N77 frequency band, and an N78 frequency band, and the corresponding relationships, each representing a relationship between each of the sub-frequency bands in the preset frequency band and a corresponding power backoff value, under the plurality of power adjustment scenarios comprise at least one of corresponding relationships, each representing a relationship between each sub-frequency band in the WiFi 5G frequency band and a corresponding power backoff value, under the plurality of the power adjustment scenarios, corresponding relationships, each representing a relationship between each sub-frequency band in the N77 frequency band and a corresponding power backoff value, under the plurality of the power adjustment scenarios, and corresponding relationships, each representing a relationship between each sub-frequency band in the N78 frequency band and a corresponding power backoff value, under the plurality of the power adjustment scenarios.

8. The antenna power adjustment method according to claim 7, wherein when the preset frequency band comprises the WiFi 5G frequency band, the power adjustment scenarios comprise one of a body approaching scenario, a limb approaching scenario, and a hotspot on-state scenario; in the hotspot on-state scenario, a hotspot of the electronic device is in an on state; the determining a current power adjustment scenario, comprises:
determining that the current power adjustment scenario is the body approaching scenario when it is determined that the electronic device is both in the body approaching scenario and the hotspot on-state scenario; and
determining that the current power adjustment scenario is the hotspot on-state scenario when it is determined that the electronic device is both in the limb approaching scenario and the hotspot on-state scenario.

9. The antenna power adjustment method according to claim 2, wherein determining that the antenna operating frequency is a frequency in a preset frequency band comprising a plurality of sub-frequency bands, comprises:
determining that the antenna operating frequency is the frequency in the preset frequency band comprising the sub-frequency bands when it is determined that the antenna operating frequency is within a frequency range in a preset frequency band defined in a preset relationship.

10. The antenna power adjustment method according to claim 1, wherein the electronic device comprises at least one feed source, and each feed source is connected to at least one antenna radiator and is configured to provide a radio frequency excitation signal for the antenna radiator; the controlling power of a target antenna radiator currently operating at the antenna operating frequency to be lowered by the target power backoff value, comprises:
controlling transmission power of a feed source connected to the target antenna radiator to be lowered by a corresponding power value, to control the power of the target antenna radiator to be lowered by the target power backoff value.

11. An electronic device, comprising:
a plurality of antenna radiators;
a processor, configured to determine a current power adjustment scenario and an antenna operating frequency of the electronic device for currently transmitting and receiving an electromagnetic wave signal, determine a target sub-frequency band in which the antenna operating frequency is located when it is determined that the antenna operating frequency is a frequency in a preset frequency band comprising a plurality of sub-frequency bands, determine a target power backoff value corresponding to the target sub-frequency band in which the antenna operating frequency is located based on power backoff values of the sub-frequency bands in the preset frequency band under the corresponding power adjustment scenario, and control power of a target antenna radiator currently operating at the antenna operating frequency to be lowered by the target power backoff value.

12. The electronic device according to claim 11, wherein the electronic device further comprises a memory, the memory is configured to store a plurality of pre-generated corresponding relationships, each representing a relationship between each of the sub-frequency bands in the preset frequency band and a corresponding power backoff value, under a plurality of power adjustment scenarios; the processor is configured to obtain a plurality of pre-generated corresponding relationships, each representing a relationship between each of the sub-frequency bands in the preset frequency band and a corresponding power backoff value, under a plurality of power adjustment scenarios, and determine the target power backoff value corresponding to the target sub-frequency band in which the antenna operating frequency is located under the current power adjustment scenario based on a corresponding relationship under the current power adjustment scenario.

13. The electronic device according to claim 12, wherein the processor is configured to divide the preset frequency band into the sub-frequency bands, determine every power backoff value corresponding to each of the sub-frequency bands in the preset frequency band under the plurality of the power adjustment scenarios respectively, to obtain the corresponding relationships, each representing a relationship between each of the sub-frequency bands in the preset frequency band and a corresponding power backoff value, under the plurality of the power adjustment scenarios, and store the corresponding relationships in the memory.

14. The electronic device according to claim 12, wherein the electronic device includes an earpiece, and the processor determining a current power adjustment scenario, comprises: the processor determining a state of the earpiece, wherein the state of the earpiece comprises an on state and an off state, and the processor determining the current power adjustment scenario based on the state of the earpiece, wherein the power adjustment scenarios comprise at least one of a body approaching scenario and a limb approaching scenario.

15. The electronic device according to claim 12, wherein the electronic device comprises a plurality of proximity sensors arranged at different positions of the electronic device respectively, each of the proximity sensors is configured to generate a sensing signal when sensing an approach of a human body; the processor determining a current power adjustment scenario, comprises: the processor determining the current power adjustment scenario based on a position of at least one of the proximity sensors that generates the sensing signal, wherein the power adjustment scenarios comprise at least one of a body approaching scenario and a limb approaching scenario.

16. The electronic device according to claim 12, wherein the preset frequency band comprises a frequency band with a bandwidth greater than a preset value, and the number of the preset frequency band is not less than one.

17. The electronic device according to claim 16, wherein the preset frequency band comprises at least one of a WiFi 5G frequency band, an N77 frequency band, and an N78 frequency band, and the corresponding relationships, each representing a relationship between each of the sub-frequency bands in the preset frequency band and a corresponding power backoff value, under the plurality of power adjustment scenarios comprises at least one of corresponding relationships, each representing a relationship between each sub-frequency band in the WiFi 5G frequency band and a corresponding power backoff value, under the plurality of the power adjustment scenarios, corresponding relationships, each representing a relationship between each sub-frequency band in the N77 frequency band and a corresponding power backoff value, under the plurality of the power adjustment scenarios, and corresponding relationships, each representing a relationship between each sub-frequency band in the N78 frequency band and a corresponding power backoff value, under the plurality of the power adjustment scenarios.

18. The electronic device according to claim 17, wherein when the preset frequency band comprises the WiFi 5G frequency band, the power adjustment scenarios comprise one of a body approaching scenario, a limb approaching scenario, and a hotspot on-state scenario; in the hotspot on-state scenario, a hotspot of the electronic device is in an on state; the processor determining a current power adjustment scenario, comprises: determining that the current power adjustment scenario is the body approaching scenario when it is determined that the electronic device is both in the body approaching scenario and the hotspot on-state scenario; and determining that the current power adjustment scenario is the hotspot on-state scenario when it is determined that the electronic device is both in the limb approaching scenario and the hotspot on-state scenario.

19. (canceled)

20. A non-transitory computer-readable storage medium, configured to store a program, wherein the program is configured to be called by a processor to execute an antenna power adjustment method, the method comprises:
determining a current power adjustment scenario;
determining an antenna operating frequency of the electronic device for currently transmitting and receiving an electromagnetic wave signal;
determining a target sub-frequency band in which the antenna operating frequency is located when it is determined that the antenna operating frequency is a frequency in a preset frequency band comprising a plurality of sub-frequency bands, and determining a target power backoff value corresponding to the target sub-frequency band in which the antenna operating frequency is located based on power backoff values of the sub-frequency bands in the preset frequency band under the corresponding power adjustment scenario; and
controlling power of a target antenna radiator currently operating at the antenna operating frequency to be lowered by the target power backoff value.

21. The computer-readable storage medium according to claim 20, wherein the determining a target power backoff value corresponding to the target sub-frequency band in which the antenna operating frequency is located based on power backoff values of the sub-frequency bands in the preset frequency band under the corresponding power adjustment scenario, comprises:
obtaining a plurality of pre-generated corresponding relationships, each representing a relationship between each of the sub-frequency bands in the preset frequency band and a corresponding power backoff value, under a plurality of power adjustment scenarios;
determining the target power backoff value corresponding to the target sub-frequency band in which the antenna operating frequency is located under the current power adjustment scenario based on a corresponding relationship under the current power adjustment scenario.
